(19) United States
(12) Patent Application Publication
(10) Pub. No.: US 2003/0192216 A1
(43) Pub. Date: Oct. 16, 2003

(54) Escape guiding or indicating device

(76) Inventor: Ju Sheng Hsu, Chong Ho City (TW)

Correspondence Address: Ju Sheng Hsu, P.O. Box 10-69, Chong Ho, Taipei, 235, TW

(21) Appl. No.: 10/124,692

(22) Filed: Apr. 12, 2002

(51) Int. Cl. G09F 13/04; G09F 27/00; G09F 13/18

(52) U.S. Cl. 40/570; 40/455; 40/546

(57) ABSTRACT

An escape indicating device includes a board attached to a housing, a lamp device received in the housing for illuminating the board, a circuit board received in the housing, two end caps secured to the housing for retaining the elements in the housing. One or more light devices are attached to the circuit board for generating flash lights, and a speaker device is attached to the circuit board for generating warning sounds. A processor device may couple the detectors of every floors of the building to the circuit board for telling people which floor has been on fire.

### BACKGROUND OF THE INVENTION

1. Field of the Invention

The present invention relates to an indicating device, and more particularly to an escape guiding and/or indicating device.

2. Description of the Prior Art

Typical escape guiding or indicating devices comprise a housing having a transparent or semi-transparent panel provided on the front portion thereof and having a light device disposed in the housing for illuminating the indication applied or provided on the front panel of the housing. However, the indication provided on the panel may not be clearly seen particularly in the smoke area. In addition, the escape indicating device may not be easily assembled or attached onto the wall member. Furthermore, the electric elements or parts received in the housing may be easily damaged or burned in fire.

The present invention has arisen to mitigate and/or obviate the afore-described disadvantages of the conventional escape indicating devices.

### SUMMARY OF THE INVENTION

The primary objective of the present invention is to provide an escape indicating device including a flash light device and a buzzer device, for allowing the users to clearly see the warning lights, and to clearly hear the warning sounds or indicating sounds.

The other objective of the present invention is to provide an escape indicating device including a solid housing for receiving and protecting the electrical elements or parts therein.

The further objective of the present invention is to provide an escape indicating device including a structure for easily assembling purposes, and for easily coupling or switching to direct current (DC) source or alternative current (AC) source.

In accordance with one aspect of the invention, there is provided an escape indicating device comprising a housing including an upper portion, and including at least one chamber formed therein, and including a lower portion, and including two ends, an indicating board attached to the lower portion of the housing, a lamp device received in the chamber of the housing for lighting the indicating board, a circuit board received in the chamber of the housing, two end caps secured to the ends of the housing for retaining the indicating board and the lamp device and the circuit board in the chamber of the housing, at least one light device attached to the circuit board for generating flash lights, and a speaker device attached to the circuit board for generating warning sounds.

The housing includes a channel formed in the lower portion thereof and defined by a pair of flanges, the indicating board includes an upper portion having a pair of grooves formed therein for receiving the flanges and for detachably securing the indicating board to the housing.

One of the end caps includes a plug for coupling the circuit board to an electric power source, and a switch for selectively coupling the electric power source to an AC or a DC power source. The other end cap includes a socket provided thereon, and a testing knob attached thereon.

A bar is further provided and resiliently coupled to the upper portion of the housing. The housing includes a passage formed in the upper portion thereof, at least one fastener secured to the bar and having a head slidably engaged in the passage of the housing, the resiliently coupling means includes at least one spring engaged between the housing and the bar.

The resiliently coupling means includes at least one second fastener secured to the bar, a washer engaged on the at least one second fastener and engaged with the upper portion of the housing, the at least one spring is engaged between the washer and the bar.

One or more detectors may further be coupled to the circuit board directly, or indirectly via a processor device. The housing includes a reflecting panel aligned with the at least one light device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of an escape indicating device in accordance with the present invention;

FIG. 2 is a partial exploded view of the escape indicating device;

FIGS. 3 and 4 are perspective views showing the elements of the escape indicating device;

FIGS. 5, 6, 7, and 8 are perspective views illustrating the operation of the escape indicating device; and

FIG. 9 is a plan view illustrating the operation and the arrangement of the escape indicating device.

### DETAILED DESCRIPTION OF THE PREFERRED EMBODIMENT

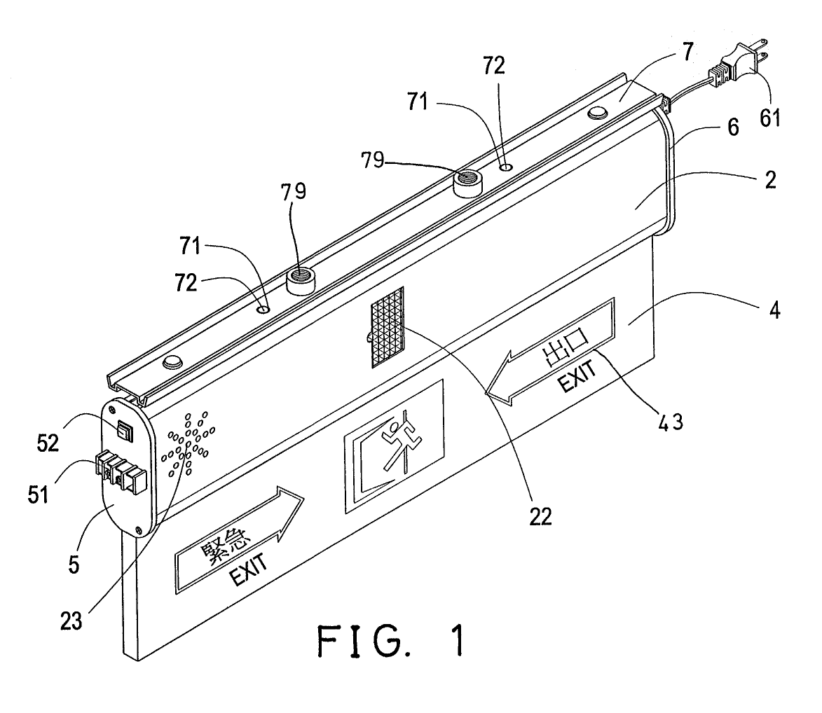

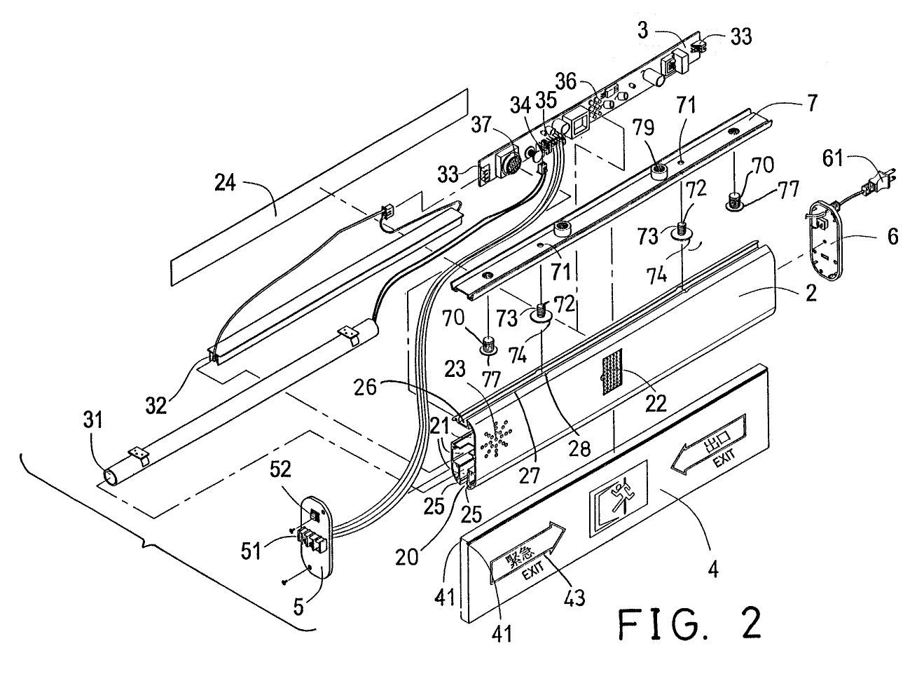

Referring to the drawings, and initially to FIGS. 1 and 2, an escape indicating device in accordance with the present invention comprises a housing 2 made of such as the aluminum alloy materials and/or to be nickeled for increasing the anti-corrosion effect to the housing 2. The housing 2 includes a channel 20 formed in the bottom portion thereof and formed or defined by a pair of opposite flanges 25, and includes one or more chambers 21 formed therein for receiving a circuit board 3, a battery device 32, a lamp device 31, etc. A plate 24 may be secured to the rear portion of the housing 2 for retaining the elements or members within the chambers 21 of the housing 2.

An indicating board 4 includes a pair of longitudinal grooves 41 formed in the upper portion thereof for slidably receiving the flanges 25 of the housing 2 and for detachably securing the indicating board 4 to the housing 2. The indicating board 4 may include various kinds of indicating signs 43 applied thereon for indicating the way for escaping, etc., and may further include a light device (not shown) for illuminating the indicating signs 43, which may also be illuminated by the lamp device 31 via the channel 20 of the housing 2. The housing 2 includes a passage 26 formed in the upper portion thereof, and formed or defined by a pair of opposite ribs 27 which may include one or more openings 28 formed therein.

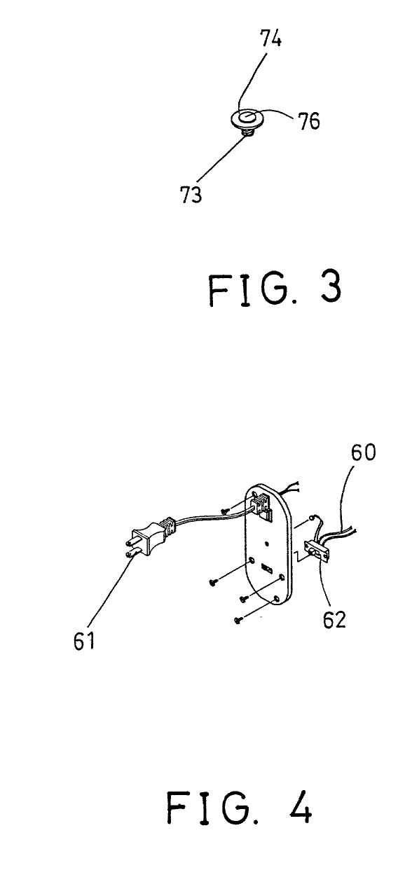

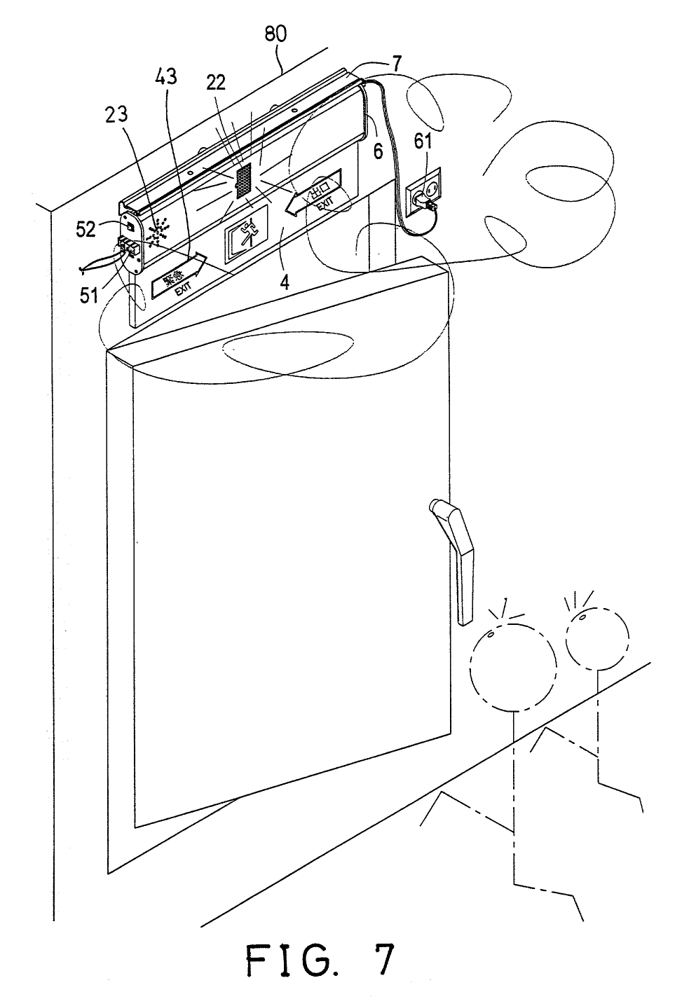

A bar 7 is provided on top of the housing 2 and may be directly secured onto a wall member 80 with such as the fasteners (FIG. 7). One or more fasteners 70 are threaded to the bottom of the bar 7, and each includes an enlarged head 77 slidably engaged in the passage 26 of the housing 2, for slidably attaching the bar 7 to the housing 2. One or more fasteners 72 are further provided and threaded to the screw holes 71 of the bar 7, and each includes an enlarged head 76 (FIG. 3) slidably engaged through the openings 28 of the ribs 27 of the housing 2, for allowing the fasteners 72 and the bar 7 to be slided toward and away from the housing 2. A washer 74 is engaged onto each of the fasteners 72 and engaged with the ribs 27 of the housing 2, and a spring 73 is engaged between the washer 74 and the bar 7 for biasing the bar 7 away from the housing 2.

Two caps 5, 6 may be secured to the ends of the housing 2, for blocking the ends of the chambers 21 and the channel 20 and the passage 26 of the housing 2, and for retaining the indicating board 4 and the bar 7 to the housing 2. The cap 6 includes a plug 61 for coupling to the electric power source, such as that shown in FIG. 7, and includes an electric wire 60 coupled to the circuit board 3 with a switch 62 (FIG. 4) which may be switched between an AC and a DC modes, for selectively coupling the circuit board 3 to the AC or DC electric power sources.

The circuit board 3 includes one or more high power light bulbs 36 and/or one or more buzzers or speakers 37 attached thereto, and one or more plugs or sockets 33 provided therein. For example, one of the plugs 33 may be coupled to the switch 62 and the plug 61 with the electric wire 60, for coupling to the AC power source. The other plug 33 may be coupled to such as the battery device 32, for coupling to the DC power source, for energizing the light bulbs 36 and/or the speakers 37. The circuit board 3 further includes one or more plugs or sockets 34 provided therein for coupling to the lamp device 31, or the other electric facilities.

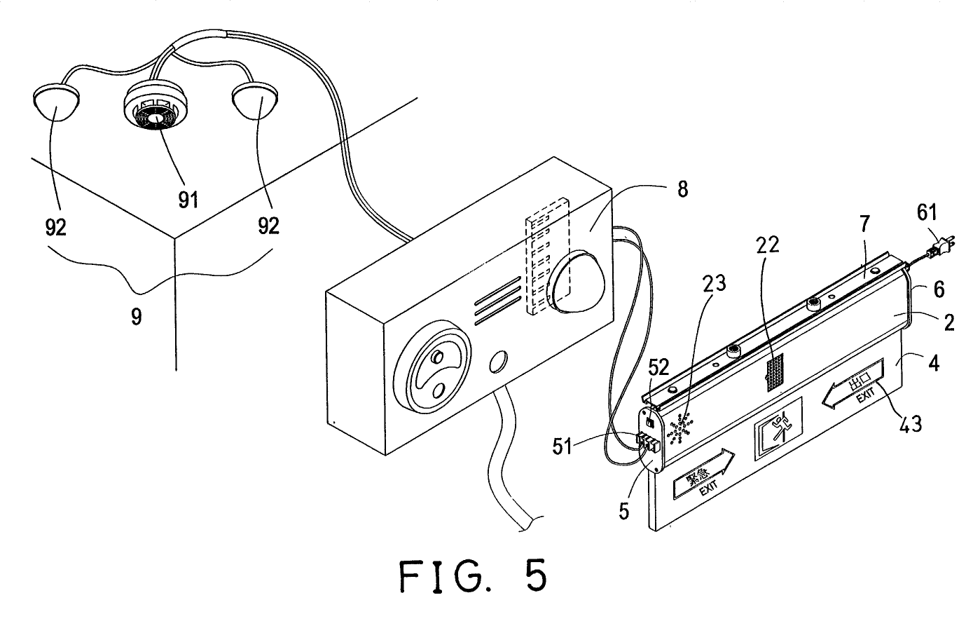

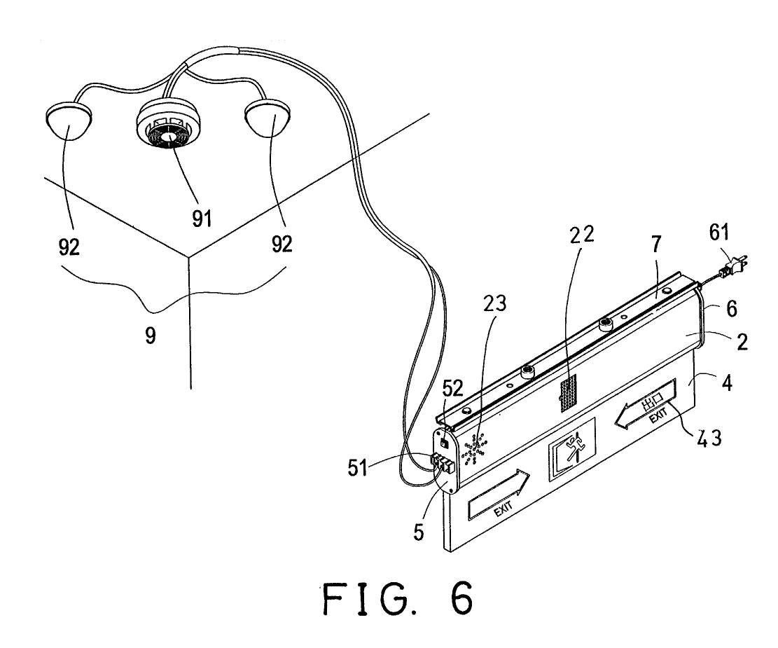

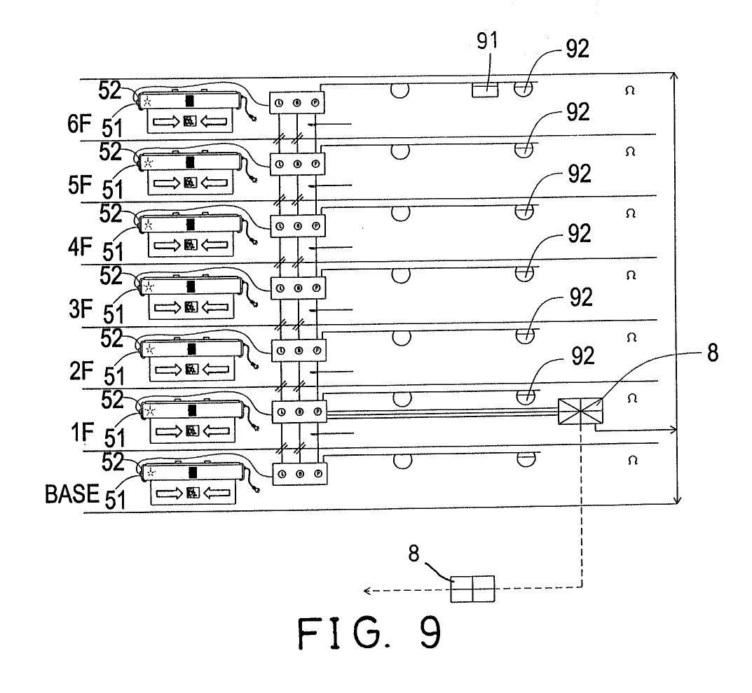

The circuit board 3 further includes a coupler or a socket 35 attached thereto or provided thereon. The other cap 5 includes a coupler or a socket 51 and a testing knob 52 provided thereon and coupled to the socket 35 of the circuit board 3. The testing knob 52 may be used for testing whether the electric power has been supplied to the circuit board 3 or not. The socket 51 may be used for coupling to the other devices, such as the sensors or detectors 9. Foe example, the socket 51 may be coupled to the smoke detector 91 and/or the temperature detectors or the temperature gauges 92 directly (FIG. 6), or indirectly via one or more processor devices 8 (FIGS. 5, 9), without disengaging or dis-assembling the housing 2.

For example, as shown in FIG. 9, the processor devices 8 may receive the signals from the detectors 9 of one or more of the floors of a building, and may be used to energize the light device or light bulbs 36 in order to generate the flash lights that may be clearly seen by the users in the smoke area, best shown in FIG. 7. When receiving the signals from the detectors 9, the processor devices 8 may also send out the signals to the speakers 37, or may energize the speakers 37 to tell people which floor has been on fire and/or to tell people which way and/or how to get out of the building.

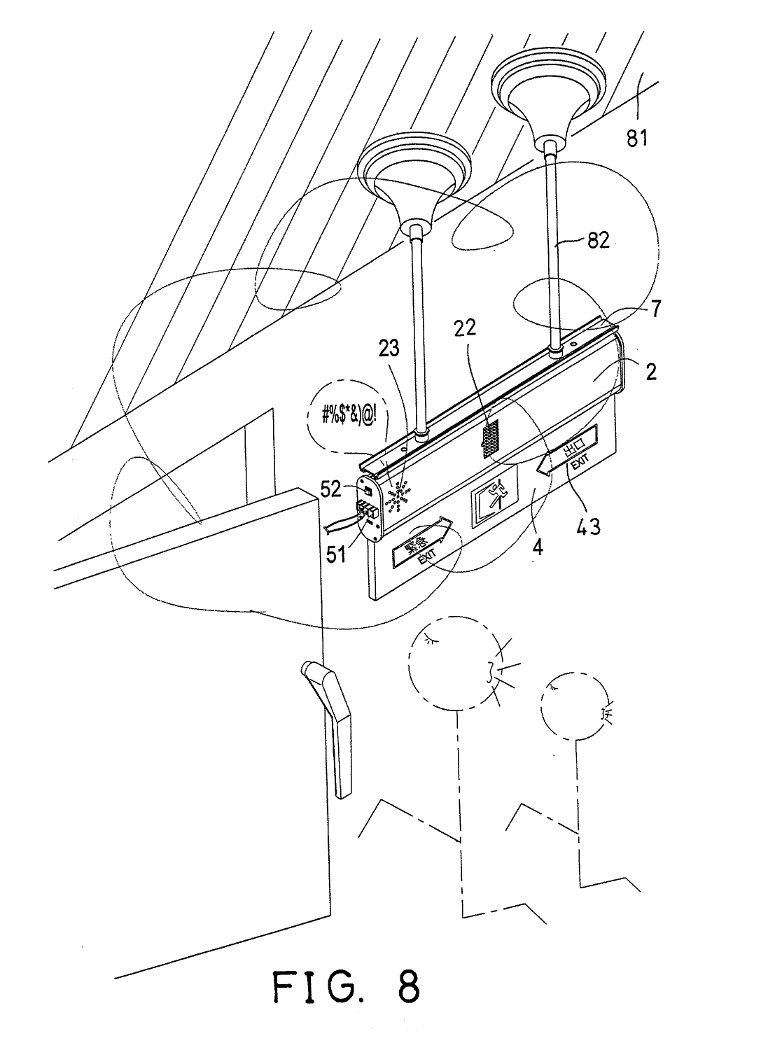

The housing 2 may include such as a reflecting panel 22 for facilitating or for reflecting the flashing lights of the light bulbs 36, and may include a number of orifices 23 aligned with the speaker 37 for allowing the warning sounds to be clearly heard by the users (FIG. 8). The housing 2 and/or the bar 7 may be secured to the ceiling 81 with one or more down rods 82 which may be threaded to such as the screw holes 79 of the bar (FIGS. 1, 2).

Accordingly, the escape indicating device in accordance with the present invention includes a flash light device and a buzzer device, for allowing the users to clearly see the warning lights, and to clearly hear the warning sounds or indicating sounds, and includes a solid housing for receiving and protecting the electrical elements or parts therein, and includes a structure for easily assembling purposes, and for easily coupling or switching to DC source or AC source.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An escape indicating device comprising:
a housing including an upper portion, and including at least one chamber formed therein, and including a lower portion, and including two ends,
an indicating board attached to said lower portion of said housing,
a lamp device received in said chamber of said housing for illuminating said indicating board,
a circuit board received in said chamber of said housing,
two end caps secured to said ends of said housing for retaining said indicating board and said lamp device and said circuit board in said chamber of said housing,
at least one light device attached to said circuit board for generating flash lights, and
a speaker device attached to said circuit board for generating warning sounds.

2. The escape indicating device according to claim 1, wherein said housing includes a channel formed in said lower portion thereof and defined by a pair of flanges, said indicating board includes an upper portion having a pair of grooves formed therein for receiving said flanges and for detachably securing said indicating board to said housing.

3. The escape indicating device according to claim 1, wherein a first of said end caps includes a plug for coupling said circuit board to an electric power source, and a switch for selectively coupling said electric power source to an AC or a DC power source.

4. The escape indicating device according to claim 1, wherein a first of said end caps includes a socket provided thereon, and a testing knob attached thereon.

5. The escape indicating device according to claim 1 further comprising a bar, and means for resiliently coupling said bar to said upper portion of said housing.

6. The escape indicating device according to claim 5, wherein said housing includes a passage formed in said upper portion thereof, at least one fastener secured to said bar and having a head slidably engaged in said passage of said housing, said resiliently coupling means includes at least one spring engaged between said housing and said bar.

7. The escape indicating device according to claim 6, wherein said resiliently coupling means includes at least one second fastener secured to said bar, a washer engaged on said at least one second fastener and engaged with said upper portion of said housing, said at least one spring is engaged between said washer and said bar.

8. The escape indicating device according to claim 1 further comprising at least one detector coupled to said circuit board.

9. The escape indicating device according to claim 8 further comprising a processor device coupled between said circuit board and said at least one detector.

10. The escape indicating device according to claim 1, wherein said housing includes a reflecting panel aligned with said at least one light device.
